(19) United States
(12) Patent Application Publication
(10) Pub. No.: US 2009/0226583 A1
(43) Pub. Date: Sep. 10, 2009

(54) COMPOSITIONS AND METHODS FOR REDUCING SPOILAGE OF LEAFY PRODUCE

(76) Inventor: Joe Jess Estrada, Castroville, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/042,647

(22) Filed: Mar. 5, 2008

(51) Int. Cl. A23B 7/16

(52) U.S. Cl. 426/321; 426/654

(57) ABSTRACT

A composition for preserving leafy produce comprises sodium hypochlorite in combination with a phosphate salt. The process comprises exposing leafy produce to the composition, drying the composition, and storing the composition at reduced temperatures.

### BACKGROUND OF THE INVENTION

1. Field of the Invention

This invention relates to compositions and methods for treating leafy produce through the application of a preservative aqueous solution to said leafy produce thereby extending the period of freshness before discoloration and wilting occurs.

The produce industry, being quite aware of the problems associated with discoloration, wilting and other symptoms of spoilage, has attempted to maintain a fresh, appealing appearance of produce as long as possible. It is well known that leafy produce, such as spinach, lettuce, chard, and the like, suffer from such spoilage after even relatively short periods of storage. Consequently, the produce-treating industry is constantly faced with unnecessarily high costs due to spoiling of produce.

The various methods which have been proposed to overcome the spoilage problem of non-leafy produce have been primarily directed to the improvement of the color of the produce, rather than maintaining freshness through application of a preservative. These methods that are used are generally designed to bleach the produce and provide a color additive. A number of these prior art methods are somewhat limited in that they have involved the use of acids and other strong chemicals which have a tendency to injure the material being treated or require very careful, critical control of the process to avoid damage to the produce.

The conventional bleaching methods used in the treatment of produce are designed to remove various stains present on the outer skin and to generally lighten the color of the produce to make it more appealing for sale. Many of these previously proposed bleaching methods, especially those involving the use of acid solutions, also tend to char or cause an undesirable reaction between the organic material and the acid constituent of the solution. Consequently, these prior art methods are often not applicable to the treatment of many types of produce and do not materially aid in extending the fresh life.

The use of oxidizing or reducing agents and providing certain color additives or to selectively bleach the produce is generally known in the art. Such oxidizing agents include hydrogen peroxide, sulfur dioxide and sodium-sulfo-paratoluene chloramine. Examples of reducing agents which may be used include copper sulfate, ferrous sulfate, ferrous sulfite, hydrogen sulfide, titaneous chloride and stannous chloride. Sodium hypochlorite is another popular oxidizing agent frequently used in prior art produce treatment processes. This compound is generally used in solutions of sufficient concentrations to cause a bleaching action to occur when the solution is applied to the produce being treated.

2. Description of the Background Art

Prior art methods designed for the bleaching of produce utilize sodium hypochlorite as well as other additives such as hydrogen peroxide, as disclosed in U.S. Pat. No. 2,092,090 to J. N. Sharma and U.S. Pat. No. 2,155,923 to J. A. Armstrong. As disclosed in these two patents, the concentration of sodium hypochlorite, or its equivalent oxidizing agent, is used only in concentrations sufficient to produce a bleaching action on the outer skins of fruits and vegetables. Sodium hypochlorite is not used as a preservative in these prior art methods.

A process employing chlorites for bleaching non-cellulosic organic materials is disclosed in U.S. Pat. No. 2,430,674 to C. A. Hampel. The use of sodium hypochlorite as a preservative is not suggested.

U.S. Pat. No. 3,978,235, to Schiro, discloses the use of sodium hypochlorite in mixture with an alkali earth metal phosphate for preserving produce and cut flowers.

The use of Milton's Solution having a sodium hypochlorite concentration from 50 to 100 ppm and a sodium chloride concentration from 825 to 1650 ppm for anti-fungal treatment of kola nuts is described in Olunloyo (1979) Niger. Jour. Agric. Sci. 1:51-59.

Additional United States patents show various preservative compositions and methods of preserving or maintaining the freshness and color of produce including fruit and vegetables. Such patents include: Hall-U.S. Pat. No. 2,082,573; Sharma-U.S. Pat. No. 2,092,090; Kalmar-U.S. Pat. No. 2,374,210; Matarozzo-U.S. Pat. No. 2,420,322; Wilson-U.S. Pat. No. 2,441,305; Gericke-U.S. Pat. No. 2,503,663; Pryor-U.S. Pat. No. 2,522,535; Bedrosian-U.S. Pat. No. 3,102,777, and Bautista-U.S. Pat. No. 6,045,846. Again, while most of these prior art patents show a preservative product or process, they do not show the use of a composition which will react with the produce in an efficient manner having no deleterious effects on either taste, smell or appearance.

Of particular interest to the present invention, U.S. Pat. No. 5,599,571, having common inventorship with the present application, describes a more effective solution for preserving the freshness of leafy produce. The solution comprises sodium or calcium hypochlorite and salt (sodium chloride). Dilute aqueous solutions of these components were found to lengthen the period at which leafy produce could be held at a reduced temperature without significant discoloration or wilting. Nonetheless, it would be desirable to provide compositions and methods which are capable of prolonging the freshness of leafy produce for even longer periods.

### BRIEF SUMMARY OF THE INVENTION

The present invention provides a process art compositions for preserving leafy produce, such as spinach, lettuce, chard, and the like. This process utilizes a composition which inhibits bacterial degradation of the produce and considerably lengthens the time that the produce being treated remains fresh and appealing. More specifically, discoloration and wilting due to the exposure of the produce to atmosphere are considerably delayed through the interaction of the produce with the constituents of the composition. Surprisingly, the composition is able to inhibit such microbial degradation and wilting without itself discoloring or otherwise degrading the sensitive leafy produce.

The preservative composition of the present invention comprises sodium or calcium hypochlorite in combination with a phosphate salt, such as trisodium phosphate (Na₃PO₄) (CAS 7601-54-9), disodium phosphate (Na₂HPO₄), tricalcium phosphate (Ca₃(PO₄)₂), and/or dicalcium phosphate (CaHPO₄). The sodium or calcium hypochlorite will be present in aqueous solution at a concentration in the range from 5% to 16% by weight, usually from 8% to 14% by weight. The combined concentrations of the phosphate salts will be in the range from 1 g/l to 5 g/l, usually from 2 g/l to 4 g/l. In the preferred embodiments, the hypochlorite will be sodium hypochlorite at a concentration of from 8% to 14% by weight and the preferred phosphates will be a combination of trisodium phosphate at from 0.5 g/l to 2.5 g/l and disodium phosphate at from 0.5 g/l to 2.5 g/l.

Methods according to the present invention utilize the compositions set forth above, where the leafy produce is first exposed to the aqueous solution, typically for a time in the range from 30 seconds to 30 minutes. The exposure is preferably by complete immersion in a “bath” of the preservative solution where the bath is maintained at or near room temperature.

Although an immersion process is the most desirable, the leafy produce could also be treated by a spray device. For example, the produce could be passed under a plurality of spray heads using a conventional conveyor arrangement. The unused solution passing through the conveyor could then be collected and recirculated back to the spray heads.

Storage of the treated produce at reduced temperatures serves to aid in the initial preservation process and further extends the life of the produce being treated. As is well known, heat tends to promote microbial growth and break down the chemical structure of produce exposed to oxygen in the atmosphere. The combination of first subjecting produce to the preservative composition and then storing the produce after treatment in a relatively cold environment, typically below 35° F., usually in the range from 35° F. to 55° F., and preferably in the range from 40° F. to 42° F., comprises an efficient method for extending the freshness of the leafy produce.

### DETAILED DESCRIPTION OF THE INVENTION

The process of the present invention for preserving leafy produce, comprises exposing the produce to be treated to a dilute aqueous solution of the preservative composition of the present invention. This preservative composition comprises an aqueous solution having from 5% to 16% by weight sodium or calcium hypochlorite and from about 0.1 g/l to 5 g/l phosphate salt with the remainder being water. The preferred composition will comprise 8% to 14% by weight sodium or calcium hypochlorite and 1 g/l to 2 g/l trisodium phosphate and 1 g/l to 2 g/l disodium phosphate in water. Frequently, the compositions utilized in the method of the present invention will be prepared as concentrated solutions which may then be diluted with water to provide for final concentrations as set forth above. The temperature at which the solution is maintained may be varied and has little practical effect over the outcome of the process as long as the temperature range of the bath is maintained between about 34° F. and about 85° F., usually being at or near room temperature.

In the practice of the present invention, therefore, the process for preserving produce comprises:

a) forming a preservative composition comprising at least one potassium salt, a chloride salt, and water;
b) optionally forming a dilute aqueous solution from a concentrate by adding the preservative composition to water;
c) subjecting the produce to the dilute aqueous solution for a period of time from about 0.5 to about 30 minutes; and
d) removing the produce from the dilute aqueous solution.

The process may further comprise drying the treated produce and storing it at a reduced temperature.

Treatment of the leafy produce comprises either immersing the produce in or spraying the produce with the dilute aqueous solution from 0.5 to 30 minutes, with an optimum period being up to about 5 minutes. Immersion is preferred. Subsequent to drying, the treated produce is stored at a reduced temperature in the range of from about 35° F. to about 45° F. Ideally, dependent upon the particular produce being treated, the preferred storage temperature is from about 38° F. to about 42° F.

The following examples are offered by way of illustration and are not to be construed as limiting the scope of the invention.

### EXPERIMENTAL

Three preservative compositions were prepared. A first consisted of 10% sodium hypochlorite by weight in water. The second consisted of 10% sodium hypochlorite in water with the addition of 7.9 g/l sodium chloride. The third preservative composition was representative of the present invention and consisted of 10% sodium hypochlorite with 1.5 g/l disodium phosphate and 1.5 g/l trisodium phosphate present in water. The disodium phosphate was first dissolved in hot water prior to combining with the other components of the solution.

Spinach samples were dipped for two minutes in each of the three preservative compositions at room temperature and then spun dry for four minutes. The treated spinach samples were then packaged into 10 oz. plastic bags, with ten plastic bags being placed in individual cartons. One carton of each of the three treated spinach products was tested. The cartons were placed into a cold box at 36° F. After thirteen and seventeen days from the start of the test, spinach samples from each of the three cartons were observed. The samples were judged on color, taste, and wilting. At thirteen days, the produce from the preservative composition of the present invention was judged to be very good on these three criteria, while that from the sodium hypochlorite/sodium chloride control was found to be good, and that from the sodium hypochlorite only control was found to be dried out and/or wilted. After seventeen days, the product preserved in the composition of the present invention was found to be better in crispness and color than that from the sodium hypochlorite/sodium chloride control, and the sodium hypochlorite only control was entirely wilted.

While the above is a complete description of the preferred embodiments of the invention, various alternatives, modifications, and equivalents may be used. Therefore, the above description should not be taken as limiting the scope of the invention which is defined by the appended claims.

What is claimed is:

1. An aqueous solution for inhibiting wilting and discoloration of leafy produce, said solution comprising:
at least one of sodium hypochlorite and calcium hypochlorite at a combined concentration in the range from 5% to 16% by weight;
at least one of trisodium phosphate (Na₃PO₄), disodium phosphate (Na₂HPO₄), tricalcium phosphate (Ca₃(PO₄)₂), and dicalcium phosphate (CaHPO₄), at a combined concentration in the range from 0.5 g/l to 3 g/l; and
water.

2. An aqueous solution as in claim 1, comprising sodium hypochlorite at a concentration from 8% to 14%.

3. An aqueous solution as in claim 2, comprising trisodium phosphate at 0.25 g/l to 0.75 g/l and disodium phosphate at 0.25 g g/l to 0.75 g/l.

4. A method for inhibiting wilting and discoloration of leafy produce, said method comprising:
exposing the leafy produce to an aqueous solution as in claim 1; and
storing the leafy produce at a reduced temperature.

5. A method as in claim 4, further comprising the step of drying the produce after exposure to the aqueous solution.

6. A method as in claim 4, wherein the reduced temperature is in the range from 35° F. to 55° F.

7. A method as in claim 6, wherein the reduced temperature is in the range from 40° F. to 42° F.

8. A method as in claim 1, wherein the leafy produce is maintained at the reduced temperature for at least 10 days without substantial wilting or discoloration.
